(19) United States
(12) Patent Application Publication
(10) Pub. No.: US 2025/0260523 A1
(43) Pub. Date: Aug. 14, 2025

(54) Method And Apparatus For Efficient Spectrum Aggregation With A Multi-Cluster BWP In Mobile Communications

(71) Applicant: MediaTek Inc., Hsinchu City (TW)

(72) Inventor: Pei-Kai Liao, Hsinchu City (TW)

(21) Appl. No.: 18/859,180

(22) PCT Filed: Apr. 21, 2023
(86) PCT No.: PCT/CN2023/089894

§ 371 Date: Oct. 23, 2024

Related U.S. Application Data
(60) Provisional application No. 63/335,244, filed on Apr. 27, 2022.

(51) Int. Cl. H04L 5/00; H04L 5/14; H04L 27/26

(52) U.S. Cl. CPC H04L 5/001; H04L 5/0039; H04L 5/14; H04L 27/26025; H04L 27/2605

(57) ABSTRACT

Various solutions for efficient spectrum aggregation in mobile communications are described. An apparatus may receive a cell configuration from a network node of a wireless network. The cell configuration may include a plurality of component carrier (CC) configurations, each of which is corresponding to a respective one of a plurality of CCs associated with a cell. The apparatus may receive one or more bandwidth part (BWP) configurations from the network node. Each of the one or more BWP configuration may indicate a BWP including one or more radio resource clusters, each of which includes a set of physically contiguous radio resources within one of the CCs. The apparatus may perform a carrier aggregation within the cell based on the CC configurations and the one or more BWP configurations.

### CROSS REFERENCE TO RELATED PATENT APPLICATION(S)

The present disclosure is part of U.S. National Stage filing of International Patent Application No. PCT/CN2023/089894, filed 21 Apr. 2023, which claims the priority benefit of U.S. Patent Application No. 63/335,244, filed 27 Apr. 2022, the content of which herein being incorporated by reference in its entirety.

### TECHNICAL FIELD

The present disclosure is generally related to mobile communications and, more particularly, to efficient spectrum aggregation in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR), multi-link operation is introduced to increase system capacity and transmission efficiency of the communication systems. Multi-link operation can be implemented by carrier aggregation (CA) or dual connectivity (DC), where additional links are used to increase the amount of data that can be transferred to and from the user equipment (UE). The UE can be configured with more than one radio links (e.g., component carriers (CCs)) and can connect to more than one network nodes (e.g., serving cells). Under the current CA framework of NR, one CC is associated with one cell and the complexity/overhead of layer-one (L1) signalling increases with the number of CCs/cells. For example, when more than four CCs/cells are configured for CA, the UE's blind decoding (BD) capability may be implemented in a way that the maximum number of BD attempts per slot is confined as if there are only four CCs/cells, which comes with the cost of user-perceived throughput (UPT) degradation due to potential PDCCH blocking. Alternatively, the UE's BD capability may be implemented to support that the maximum number of BD attempts per slot increases with the real number of configured CCs/cells, but the BD complexity will inevitably affect the UE's cost. Moreover, there are (potential) common bit-fields in the respective downlink control information (DCI) for each configured CC/cell in CA, which results in DCI overhead and scheduling inefficiency.

Another issue of the 1-to-1 association between CC and cell is that when CC activation or deactivation occurs, the CC activation time is expected to be long. For example, in frequency range 1 (FR1), the CC activation time may be up to 45 milliseconds (ms) for warm activation, or may be up to 85 ms for cold activation. The long CC activation time will impact the quality of service (QoS) for applications (e.g., related to extended reality (XR)). Meanwhile, the configuration of measurement gaps in CA is complicated in a way that the UE may need to support more concurrent measurement gaps, which also takes a toll on XR capability and QoS.

In addition, another issue of the 1-to-1 association between CC and cell is that when compared to frequency-division duplexing (FDD), the time-division duplexing (TDD) configuration limits the lower bound of hybrid automatic repeat request (HARQ) latency. The long HARQ latency will impact XR capacity in TDD bands.

Therefore, solutions are sought to improve the spectrum aggregation issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to efficient spectrum aggregation in mobile communications.

In one aspect, a method may involve an apparatus receiving a cell configuration from a network node of a wireless network. The cell configuration may comprise a plurality of component carrier (CC) configurations, each of which is corresponding to a respective one of a plurality of CCs associated with a cell. The method may also involve the apparatus receiving one or more bandwidth part (BWP) configurations from the network node. Each of the one or more BWP configuration may indicate a BWP comprising one or more radio resource clusters, each of which may comprise a set of physically contiguous radio resources within one of the CCs. The method may also involve the apparatus performing a carrier aggregation within the cell based on the CC configurations and the one or more BWP configurations.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising receiving, via the transceiver, a cell configuration from the network node of the wireless network. The cell configuration may comprise a plurality of CC configurations, each of which is corresponding to a respective one of a plurality of CCs associated with a cell. The processor may also perform operations comprising receiving, via the transceiver, one or more BWP configurations from the network node. Each of the one or more BWP configuration may indicate a BWP comprising one or more radio resource clusters, each of which comprises a set of physically contiguous radio resources within one of the CCs. The processor may further perform operations comprising performing, via the transceiver, a carrier aggregation within the cell based on the CC configurations and the one or more BWP configurations.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of the concept of a discrete cell under schemes in accordance with implementations of the present disclosure.

FIG. 2 is a diagram depicting an example scenario of defining the component carriers (CCs) of a discrete cell under schemes in accordance with implementations of the present disclosure.

FIG. 3 is a diagram depicting an example scenario of a single-cluster or multi-cluster bandwidth part (BWP) under schemes in accordance with implementations of the present disclosure.

FIG. 4 is a diagram depicting an example scenario of an initial downlink (DL) BWP under schemes in accordance with implementations of the present disclosure.

FIG. 5 is a diagram depicting an example scenario of dynamic BWP adaptation under schemes in accordance with implementations of the present disclosure.

FIG. 6 is a diagram depicting an example scenario of multiple time-division duplexing (TDD) configurations for a discrete cell under schemes in accordance with implementations of the present disclosure.

FIG. 7 is a diagram depicting an example scenario of a sub-band based full duplex mode under schemes in accordance with implementations of the present disclosure.

FIG. 8 is a diagram depicting an example scenario of multiple timing advance (TA) groups for a discrete cell under schemes in accordance with implementations of the present disclosure.

FIG. 9 is a diagram depicting another example scenario of multiple TA groups for a discrete cell under schemes in accordance with implementations of the present disclosure.

FIG. 10 is a block diagram of an example communication system in accordance with an implementation of the present disclosure.

FIG. 11 is a flowchart of an example process in accordance with an implementation of the present disclosure.

FIG. 12 is a flowchart of an example process in accordance with an implementation of the present disclosure.

FIG. 13 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to power saving enhancements with a wake-up signal for a dual-radio system. According to the present disclosure, a number of possible solutions may be implemented separately or jointly. That is, although these possible solutions may be described below separately, two or more of these possible solutions may be implemented in one combination or another.

In current carrier aggregation (CA) framework of New Radio (NR), one component carrier (CC) is associated with one cell and the complexity/overhead of layer-one (L1) signalling increases with the number of CCs/cells. The 1-to-1 association between CC and cell may cause issues that impact the performance of spectrum aggregation. The issues may include blind decoding (BD) complexity, downlink control information (DCI) overhead, long CC activation time, complicated measurement gaps, and long hybrid automatic repeat request (HARQ) latency in time-division duplexing (TDD) bands, etc. Therefore, there is a need to improve the spectrum aggregation issues.

In view of the above, the present disclosure proposes a number of schemes pertaining to efficient spectrum aggregation in mobile communications. According to the schemes of the present disclosure, multiple CCs associated with one cell (or called a discrete cell) is supported. That is, the 1-to-1 association between CC and cell is decoupled, including frequency domain decoupling with physical carrier, and spatial domain decoupling with physical site. Specifically, multiple co-located CCs (i.e., CCs provided by the same network node) or non-co-located CCs (i.e., CCs provided by different network nodes) may be bundled within a cell. Moreover, according to the schemes of the present disclosure, a bandwidth part (BWP) consisting of one or more radio resource clusters is supported. The BWP consisting of multiple radio resource clusters is also called a multi-cluster BWP. Each radio resource cluster consists of a set of physically contiguous radio resources within one of the CCs of a discrete cell, and the radio resource clusters of a BWP share the same numerology (i.e., the same subcarrier spacing (SCS) and cyclic prefix (CP)). In addition, according to the schemes of the present disclosure, multiple timing advance (TA) groups for a discrete cell is supported. Each TA group is associated with a respective set of one or more of the CCs of the discrete cell, and one BWP of the discrete cell is associated with a single TA group only. Accordingly, by applying the schemes of the present disclosure, the performance of spectrum aggregation in mobile communications may be improved. Both network side and the UE side can benefit from the enhancements achieved by the implementations of the present disclosure.

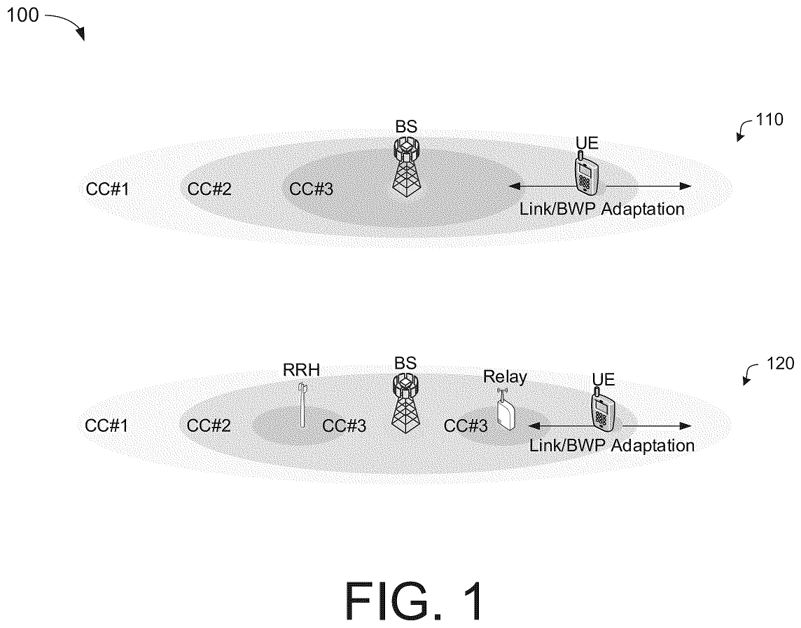

FIG. 1 illustrates an example scenario 100 of the concept of a discrete cell under schemes in accordance with implementations of the present disclosure. Scenario 100 involves a UE and one or more network nodes (e.g., a base station (BS), a relay, and/or a Remote Radio Head (RRH)), which may be a part of a wireless communication network (e.g., an LTE network, a 5G network, an NR network, an IoT network or an NB-IoT network). Diagram 110 depicts a discrete cell associated with multiple co-located CCs, i.e., the CCs provided by the same network node. The co-located CCs are synchronized, i.e., the time offset across the CCs is less than a CP. Diagram 120 depicts a discrete cell associated with multiple non-co-located CCs, i.e., the CCs provided by the different network nodes. The CCs are either localized (i.e., located in contiguous spectrum) or distributed (i.e., located in non-contiguous spectrum). The CCs are either intra-band (i.e., located in the same frequency band) or inter-band (i.e., across different frequency bands). In some implementations, a cell-defining synchronization signal block (SSB) (e.g., including an SSB and system information broadcast with cell information) is transmitted/received on an anchor CC only, while no or sparse non-cell-defining SSB (e.g., including an SSB only) is transmitted/received on other CCs. Note that different duplex modes, such as frequency-division duplexing (FDD) mode, TDD mode, flexible duplex mode, and sub-band full duplex mode, across CCs within a discrete cell are supported. For example, CC #1 is configure with FDD mode, CC #2 is configure with TDD mode, and CC #3 is configure with flexible duplex mode, etc.

Specifically, the UE may receive CC configurations for the CCs, each of which indicates a frequency location and a bandwidth size of a respective CC. The CC configurations may be included in a cell configuration that is received via a higher-layer signaling carried in the physical downlink shared channel (PDSCH). The higher-layer signaling may include system information broadcast (e.g., master information block (MIB), and/or system information block type 1 (SIB1) in 5G NR) or UE-specific radio resource control (RRC) signaling. Accordingly, the UE may perform carrier aggregation within the cell based on the CC configuration, and communicate data signals with the wireless network based on the carrier aggregation.

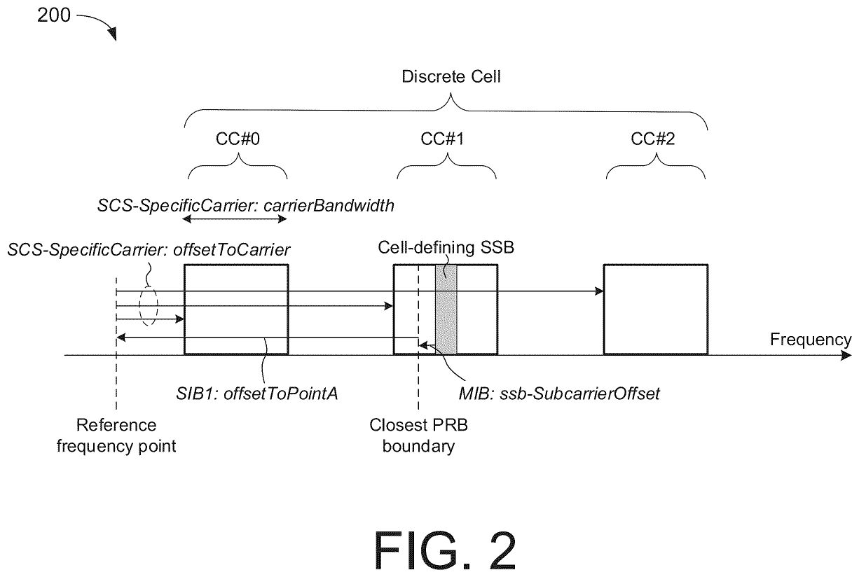

FIG. 2 illustrates an example scenario 200 of defining the CCs of a discrete cell under schemes in accordance with implementations of the present disclosure. Scenario 200 illustrates an example of defining the frequency locations and bandwidth sizes of the CCs of a discrete cell. As shown in scenario 200, there are three CCs (denoted as CC #0, CC #1, CC #2) in the discrete cell, and the frequency locations and bandwidth sizes of the CCs are defined based on a reference frequency point. Firstly, the reference frequency point is determined based on the cell-defining SSB (e.g., including an SSB and system information (e.g., MIB and/or SIB1) broadcast in 5G NR) used for initial access, e.g., based on the ssb-SubcarrierOffset information element (IE) in MIB and the offsetToPointA IE in SIB1. Secondly, the frequency location and bandwidth size of each CC are determined based on the system information (e.g., SIB1 in 5G NR) broadcast, e.g., based on the SCS-SpecificCarrier IE in SIB1.

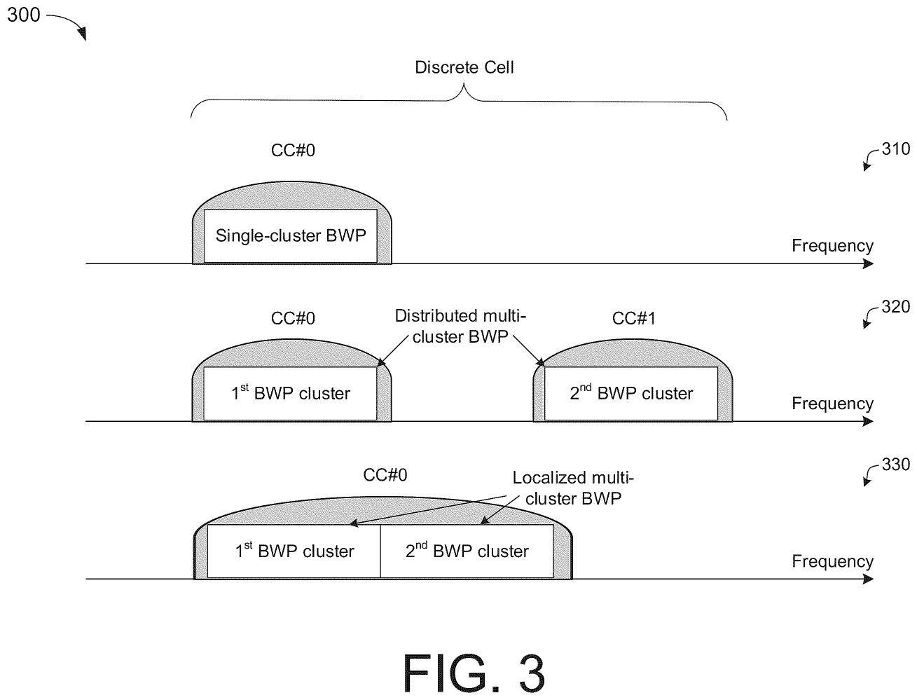

FIG. 3 illustrates an example scenario 300 of a single-cluster or multi-cluster BWP under schemes in accordance with implementations of the present disclosure. Scenario 300 illustrates an example of a cell consisting of a single-cluster BWP or a multi-cluster BWP. Diagram 310 depicts a cell with one CC consisting of a single-cluster BWP, i.e., a BWP including a single radio resource cluster within the CC. Diagram 320 depicts a cell with two non-contiguous CCs, each consisting of a respective radio resource cluster of a BWP, i.e., a multi-cluster BWP with distributed radio resource clusters (or called a distributed multi-cluster BWP). Diagram 330 depicts a cell with one CC consisting of a multi-cluster BWP, i.e., a BWP including multiple consecutive radio resource clusters within the CC (or called a localized multi-cluster BWP). For a localized multi-cluster BWP, guard band may be reserved between any two consecutive radio resource clusters, and frequency-domain overlapping clusters may enable dynamic switching between guard band reservation and no guard band reservation.

Specifically, the UE may receive one or more BWP configurations, each of which indicates a BWP comprising one or more radio resource clusters, and each radio resource cluster includes a set of physically contiguous radio resources within one of the CCs. The BWP configurations may be received via a higher-layer signaling carried in the PDSCH. The higher-layer signaling may include system information broadcast or UE-specific RRC signaling. Accordingly, the UE may perform carrier aggregation within the cell based on the BWP configurations.

In some implementations, a BWP may include a single radio resource cluster when the CC is located in licensed spectrum. In some implementations, a BWP may include a single or multiple radio resource clusters when the CC(s) is/are located in unlicensed spectrum, depending on the bandwidth(s) of the CC(s).

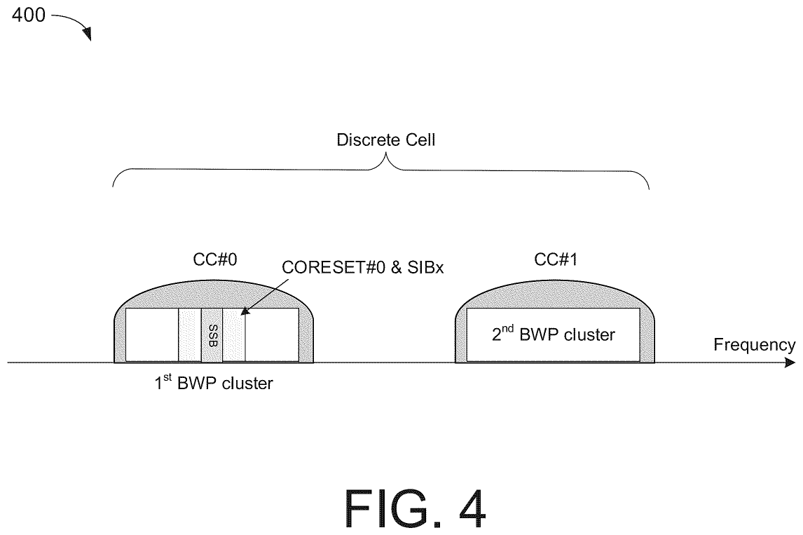

The initial downlink (DL) or uplink (UL) BWP may be a single-cluster BWP or a multi-cluster BWP. In some implementations, the initial DL BWP (or CORESET #0) provided by SSB may be a single-cluster BWP and reside in the same CC as the SSB does. In some implementations, the initial DL BWP provided by SIBx (e.g., any type of SIB) may be a single-cluster BWP or a multi-cluster BWP. FIG. 4 illustrates an example scenario 400 of an initial DL BWP under schemes in accordance with implementations of the present disclosure. Scenario 400 illustrates an example of an initial DL BWP being a multi-cluster BWP. As shown in scenario 400, the initial DL BWP provided by SIBx is a multi-cluster BWP. In such case, at least one of the radio resource clusters contains the SSB and CORESET #0, i.e., the SSB, CORESET #0, and system information (e.g., SIBx) reside in the same radio resource cluster.

In some implementations, the initial UL BWP provided by SIBx may be a single-cluster BWP or a multi-cluster BWP. For licensed spectrum, at least one of the radio resource clusters contains PRACH resources if the initial UL BWP provided by SIBx is a multi-cluster BWP. For unlicensed spectrum, each radio resource cluster shall contain PRACH resources if the initial UL BWP provided by SIBx is a multi-cluster BWP.

In some implementations, each UE-specific DL/UL BWP provided by UE-specific RRC signaling may be a single-cluster BWP or a multi-cluster BWP.

In some implementations, DL/UL applicability in time domain for a DL/UL BWP may be determined based on the TDD configurations received from the wireless network. Specifically, each TDD configuration is associated with a respective radio resource clusters of the DL/UL BWP and indicates which slot or orthogonal frequency-division multiplexing (OFDM) symbols of a slot in a radio frame is or are configured for DL or UL.

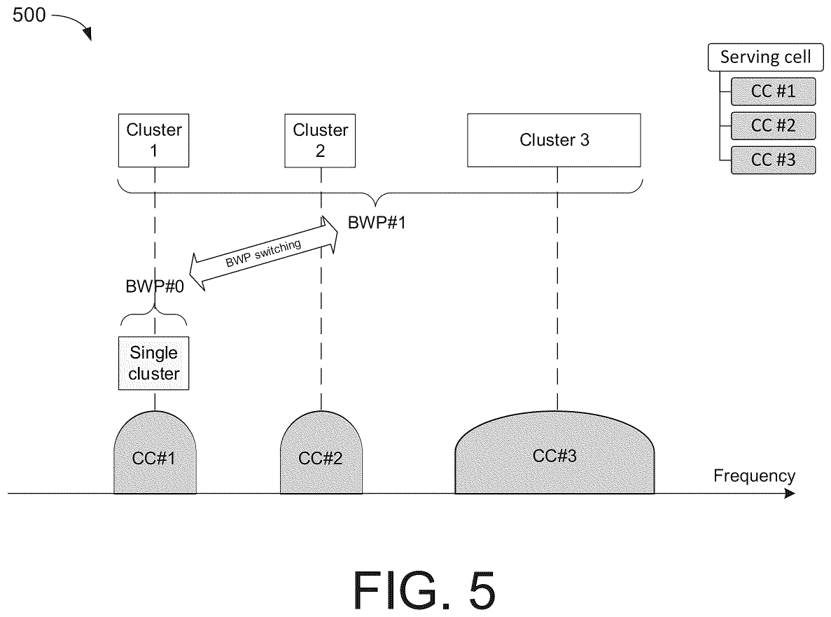

FIG. 5 illustrates an example scenario 500 of dynamic BWP adaptation under schemes in accordance with implementations of the present disclosure. Scenario 500 illustrates an example of dynamic BWP adaptation within a discrete cell. As shown in scenario 500, the active DL/UL BWP may be dynamically switched from one BWP to another BWP to better adapt to traffic load variation and to reduce power consumption. Each of the BWPs may be a single-cluster BWP (e.g., BWP #0) or a multi-cluster BWP (e.g., BWP #1). Dynamic BWP adaptation may replace at least one of the following: (1) CC #2 and CC #3 RRC-layer addition/release and MAC-layer activation/deactivation due to UE mobility; and (2) secondary CC (SCC) dormancy in CC #2 and CC #3. Measurement for CCs' channel quality may be performed based on L1 SSB or CSI-RS based reference signal received power (RSRP) on CCs for adaptation.

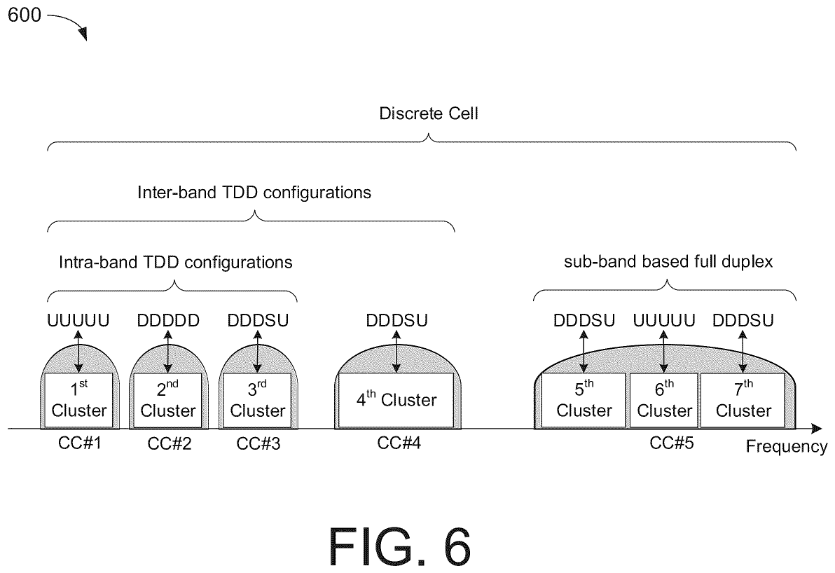

Regarding TDD configurations for a discrete cell, one or more TDD configurations for a cell is supported. Specifically, one BWP of the cell may be associated with one or more TDD configurations, while one radio resource cluster is associated with only one TDD configuration, i.e., multiple TDD configurations for single radio resource cluster is not allowed/supported but one TDD configuration may be associated with one or more radio resource clusters. FIG. 6 illustrates an example scenario 600 of multiple TDD configurations for a discrete cell under schemes in accordance with implementations of the present disclosure. Scenario 600 illustrates an example of associations between the TDD configurations and the radio resource clusters for a discrete cell. As shown in scenario 600, a discrete cell consists of a multi-cluster BWP, and each radio resource cluster of the multi-cluster BWP is associated with a respective TDD configuration. In detail, CC #1, CC #2, and CC #3 are located in the same frequency band, and the radio resource clusters in CC #1 to CC #3 are associated with different TDD configurations. For example, the TDD configuration associated with the first radio cluster in CC #1 indicates that all slots are configured for UL (denoted as U in FIG. 6). The TDD configuration associated with the second radio cluster in CC #2 indicates that all slots are configured for DL (denoted as D in FIG. 6). The TDD configuration associated with the third radio cluster in CC #3 indicates that out of these 5 slots, the first three slots are configured for DL, the last slot is configured for UL, and the fourth slot is a special slot (denoted as S in FIG. 6) (i.e., a slot in which some symbols may be used for DL, some for UL, and some are left free, e.g., to allow the transceiver to switch direction). In addition, each of CC #4 and CC #5 is located in another frequency band other than the frequency band that CC #1, CC #2, and CC #3 are located in. In particular, multiple TDD configurations associated with the radio resource clusters in CC #5 enables a sub-band based full duplex mode.

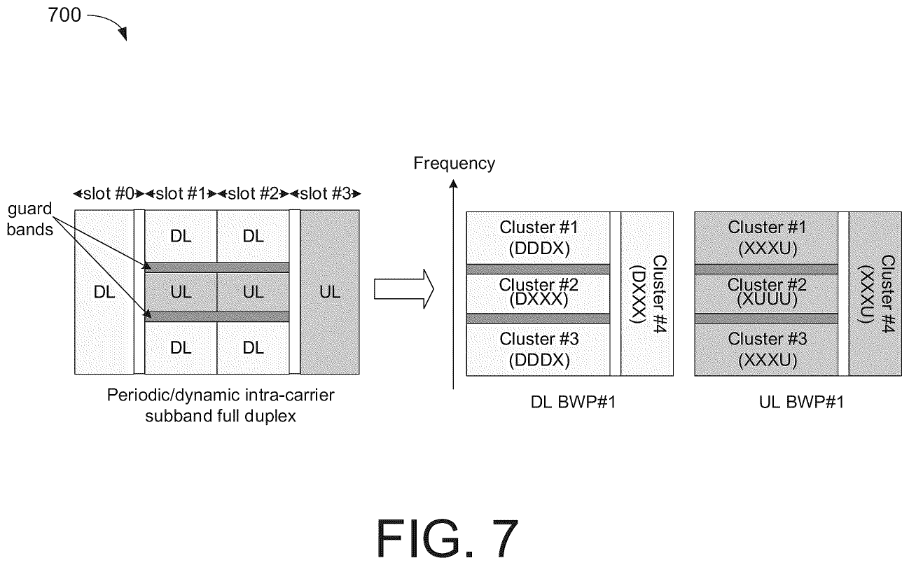

FIG. 7 illustrates an example scenario 700 of a sub-band based full duplex mode under schemes in accordance with implementations of the present disclosure. Scenario 700 illustrates an example of the sub-band based full duplex mode and associated TDD configurations. As shown in scenario 700, the TDD configurations for the radio resource clusters within the same CC indicate that the first slot (denoted as slot #0) is configured for DL, the last slot (denoted as slot #3) is configured for UL, and the two slots therebetween (denoted as slot #1 and slot #2) are special slots. Note that there are guard bands between the sub-bands in slot #1 and slot #2, and overlapping radio resource clusters enables the possibility to waive the guard bands when all sub-bands of a CC belong to DL or UL. For example, the UE may receive DL signal via four radio resource clusters and keep the received signal in BWP cluster #4 only for slot #0 to waive the guard bands, or the UE may transmit UL signal via BWP cluster #4 for slot #3 to waive the guard bands. In some implementations, the UE may receive a per-cluster periodic bitmap that indicates which slot is applicable for the associated TDD configuration to override the per-carrier TDD configuration.

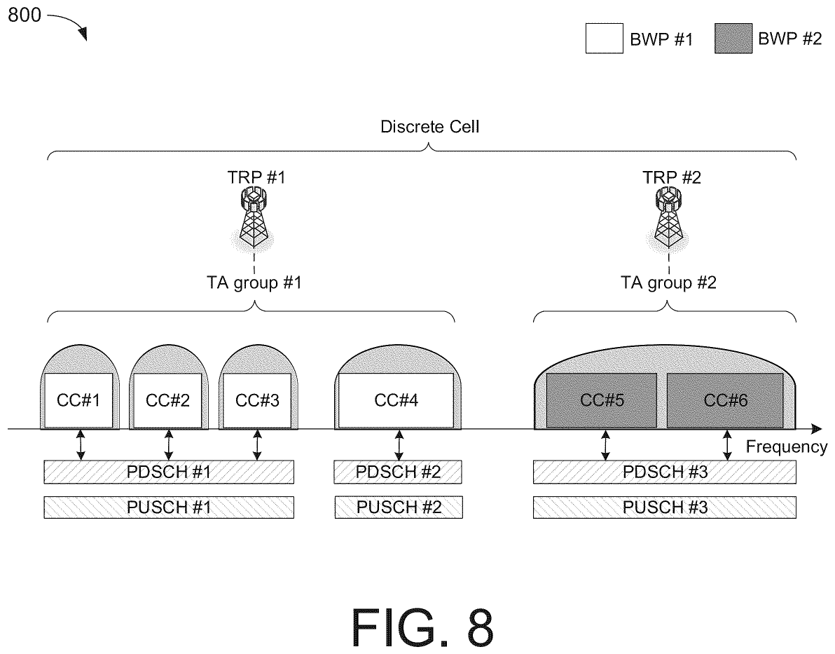

FIG. 8 illustrates an example scenario 800 of multiple TA groups for a discrete cell under schemes in accordance with implementations of the present disclosure. Scenario 800 illustrates an example of multiple TA groups associated with multiple CCs within a discrete cell. As shown in scenario 800, multiple TA groups for a discrete cell enables the support of non-co-located CCs within a cell, and one or multiple PDSCH or physical uplink shared channel (PUSCH) configurations may be configured within a discrete cell when CCs of the cell are located across different frequency bands. Specifically, one BWP is associated to single TA group only, i.e., the frequency locations and bandwidth sizes of the radio resource clusters of a BWP are confined within the CC(s) belonging to the same TA group. In some implementations, multiple active BWPs may be needed to aggregate CCs belonging to different TA groups. In some implementations, cross-BWP scheduling across different TA groups may not be allowed.

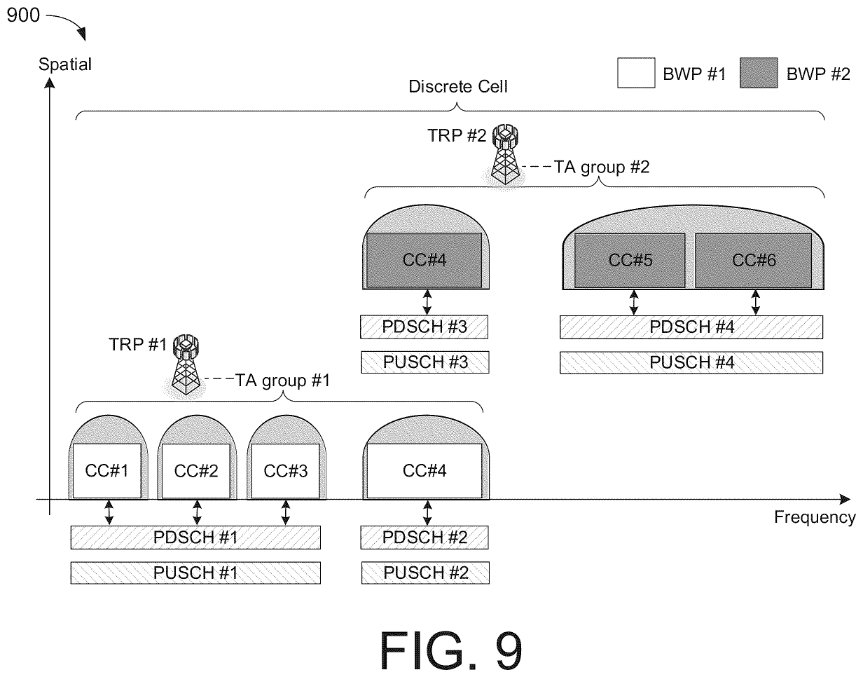

FIG. 9 illustrates an example scenario 900 of multiple TA groups under schemes in accordance with implementations of the present disclosure. Scenario 900 illustrates another example of multiple TA groups associated with multiple CCs within a discrete cell. As shown in scenario 900, one or multiple PDSCH/PUSCH configurations may be configured within a discrete cell when CCs of the cell are located across different frequency bands and different TRPs.

### Illustrative Implementations

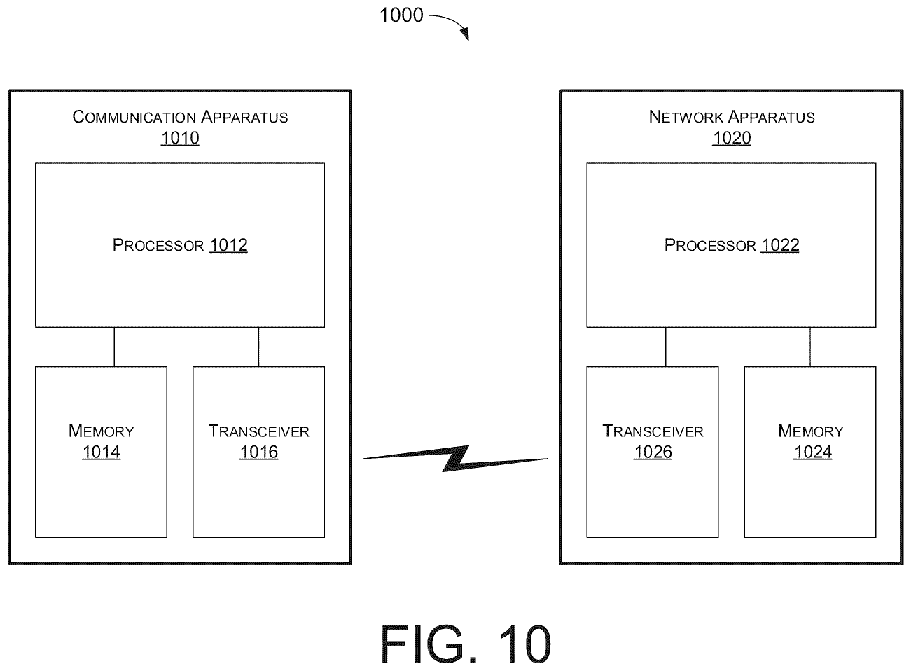

FIG. 10 illustrates an example communication system 1000 having an example communication apparatus 1010 and an example network apparatus 1020 in accordance with an implementation of the present disclosure. Each of communication apparatus 1010 and network apparatus 1020 may perform various functions to implement schemes, techniques, processes and methods described herein pertaining to efficient spectrum aggregation in mobile communications, including scenarios/schemes described above as well as processes 1100, 1200, and 1300 described below.

Communication apparatus 1010 may be a part of an electronic apparatus, which may be a UE such as a portable or mobile apparatus, a wearable apparatus, a wireless communication apparatus or a computing apparatus. For instance, communication apparatus 1010 may be implemented in a smartphone, a smartwatch, a personal digital assistant, a digital camera, or a computing equipment such as a tablet computer, a laptop computer or a notebook computer. Communication apparatus 1010 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 1010 may be implemented in a smart thermostat, a smart fridge, a smart door lock, a wireless speaker or a home control center. Alternatively, communication apparatus 1010 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1010 may include at least some of those components shown in FIG. 10 such as a processor 1012, for example. Communication apparatus 1010 may further include one or more other components not pertinent to the proposed scheme of the present disclosure (e.g., internal power supply, display device and/or user interface device), and, thus, such component(s) of communication apparatus 1010 are neither shown in FIG. 10 nor described below in the interest of simplicity and brevity.

Network apparatus 1020 may be a part of an electronic apparatus, which may be a network node such as a base station, a small cell, a router or a gateway. For instance, network apparatus 1020 may be implemented in an eNodeB in an LTE, LTE-Advanced or LTE-Advanced Pro network or in a gNB in a 5G, NR, IoT, NB-IoT or IIoT network. Alternatively, network apparatus 1020 may be implemented in the form of one or more IC chips such as, for example and without limitation, one or more single-core processors, one or more multi-core processors, or one or more RISC or CISC processors. Network apparatus 1020 may include at least some of those components shown in FIG. 10 such as a processor 1022, for example. Network apparatus 1020 may further include one or more other components not pertinent to the proposed scheme of the present disclosure (e.g., internal power supply, display device and/or user interface device), and, thus, such component(s) of network apparatus 1020 are neither shown in FIG. 10 nor described below in the interest of simplicity and brevity.

In one aspect, each of processor 1012 and processor 1022 may be implemented in the form of one or more single-core processors, one or more multi-core processors, or one or more CISC processors. That is, even though a singular term “a processor” is used herein to refer to processor 1012 and processor 1022, each of processor 1012 and processor 1022 may include multiple processors in some implementations and a single processor in other implementations in accordance with the present disclosure. In another aspect, each of processor 1012 and processor 1022 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1012 and processor 1022 is a special-purpose machine specifically designed, arranged and configured to perform specific tasks including autonomous reliability enhancements in a device (e.g., as represented by communication apparatus 1010) and a wireless network (e.g., as represented by network apparatus 1020) in accordance with various implementations of the present disclosure.

In some implementations, communication apparatus 1010 may also include a transceiver 1016 coupled to processor 1012 and capable of wirelessly transmitting and receiving data. In some implementations, communication apparatus 1010 may further include a memory 1014 coupled to processor 1012 and capable of being accessed by processor 1012 and storing data therein. In some implementations, network apparatus 1020 may also include a transceiver 1026 coupled to processor 1022 and capable of wirelessly transmitting and receiving data. In some implementations, network apparatus 1020 may further include a memory 1024 coupled to processor 1022 and capable of being accessed by processor 1022 and storing data therein. Accordingly, communication apparatus 1010 and network apparatus 1020 may wirelessly communicate with each other via transceiver 1016 and transceiver 1026, respectively. To aid better understanding, the following description of the operations, functionalities and capabilities of each of communication apparatus 1010 and network apparatus 1020 is provided in the context of a mobile communication environment in which communication apparatus 1010 is implemented in or as a communication apparatus or a UE and network apparatus 1020 is implemented in or as a network node of a wireless network.

In some implementations, processor 1012 may receive, via transceiver 1016, a cell configuration from network apparatus 1020. The cell configuration may include a plurality of CC configurations, each of which is corresponding to a respective one of a plurality of CCs associated with a cell. Then, processor 1012 may perform, via transceiver 1016, a carrier aggregation within the cell based on the CC configurations. Also, processor 1012 may communicate, via transceiver 1016, data signals with network apparatus 1020 based on the carrier aggregation.

In some implementations, processor 1012 may receive, via transceiver 1016, a cell configuration from network apparatus 1020. The cell configuration may include a plurality of CC configurations, each of which is corresponding to a respective one of a plurality of CCs associated with a cell. Then, processor 1012 may receive, via transceiver 1016, one or more BWP configurations from network apparatus 1020. Each of the one or more BWP configuration indicates a BWP including one or more radio resource clusters, each of which includes a set of physically contiguous radio resources within one of the CCs. Also, processor 1012 may perform, via transceiver 1016, a carrier aggregation within the cell based on the CC configurations and the one or more BWP configurations.

In some implementations, processor 1012 may receive, via transceiver 1016, a cell configuration from network apparatus 1020. The cell configuration may include a plurality of CC configurations, each of which is corresponding to a respective one of a plurality of CCs associated with a cell. Then, processor 1012 may receive, via transceiver 1016, a TA group configuration from network apparatus 1020. The TA group configuration indicates a plurality of TA groups of the cell, each of which is associated with a respective set of one or more of the CCs. Also, processor 1012 may receive, via transceiver 1016, an indication of a first active UL/DL BWP for a first one of the TA groups from network apparatus 1020. After that, processor 1012 may switch the first active UL/DL BWP from a first UL/DL BWP to a second UL/DL BWP based on the indication of the first active UL/DL BWP. The first and second UL/DL BWPs are associated with the first one of the TA groups.

### Illustrative Processes

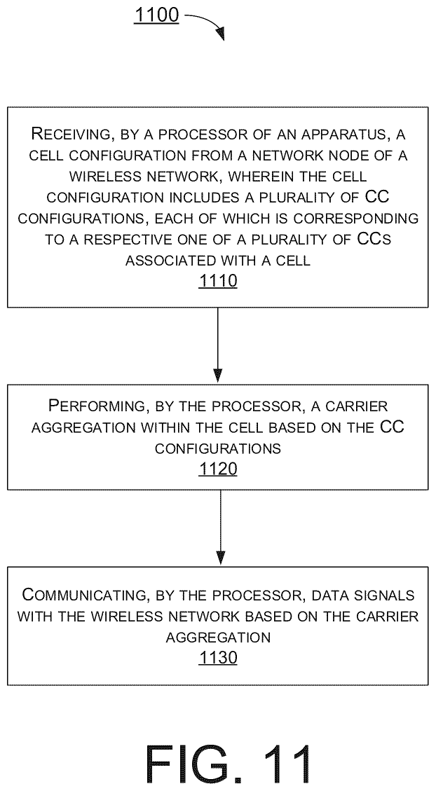

FIG. 11 illustrates an example process 1100 in accordance with an implementation of the present disclosure. Process 1100 may be an example implementation of above scenarios/schemes, whether partially or completely, with respect to efficient spectrum aggregation with a discrete cell in mobile communications. Process 1100 may represent an aspect of implementation of features of communication apparatus 1010. Process 1100 may include one or more operations, actions, or functions as illustrated by one or more of blocks 1110 to 1130. Although illustrated as discrete blocks, various blocks of process 1100 may be divided into additional blocks, combined into fewer blocks, or eliminated, depending on the desired implementation. Moreover, the blocks of process 1100 may be executed in the order shown in FIG. 11 or, alternatively, in a different order. Process 1100 may be implemented by communication apparatus 1010 or any suitable UE or machine type devices. Solely for illustrative purposes and without limitation, process 1100 is described below in the context of communication apparatus 1010. Process 1100 may begin at block 1110.

At 1110, process 1100 may involve a processor (e.g., processor 1012) of an apparatus (e.g., communication apparatus 1010) receiving, via a transceiver (e.g., transceiver 1016), a cell configuration from a network node (e.g., network apparatus 1020) of a wireless network (e.g., 5G NR network), wherein the cell configuration includes a plurality of CC configurations, each of which is corresponding to a respective one of a plurality of CCs associated with a cell. Process 1100 may proceed from 1110 to 1120.

At 1120, process 1100 may involve the processor performing a carrier aggregation within the cell based on the CC configurations. Process 1100 may proceed from 1120 to 1130.

At 1130, process 1100 may involve the processor communicating data signals with the wireless network based on the carrier aggregation.

In some implementations, each of the CC configurations indicates a frequency location and a bandwidth size of a respective one of the CCs.

In some implementations, the cell configuration is received via a higher-layer signaling. The higher-layer signaling may include system information broadcast or UE-specific RRC signaling.

In some implementations, the CCs are provided by a single network node or multiple network nodes.

In some implementations, the CCs are located in the same frequency band or across different frequency bands.

In some implementations, process 1100 may further involve the processor receiving, via the transceiver, a cell-defining SSB on a first CC of the CCs. The cell-defining SSB may include a first SSB and system information broadcast with cell information.

In some implementations, process 1100 may further involve the processor receiving, via the transceiver, a non-cell-defining SSB on a second CC of the CCs. The non-cell-defining SSB may include a second SSB only.

In some implementations, each of the CCs is configured with one of the following duplex modes: (1) a FDD mode, (2) a TDD mode, (3) a flexible duplex mode, and (4) a sub-band full duplex mode.

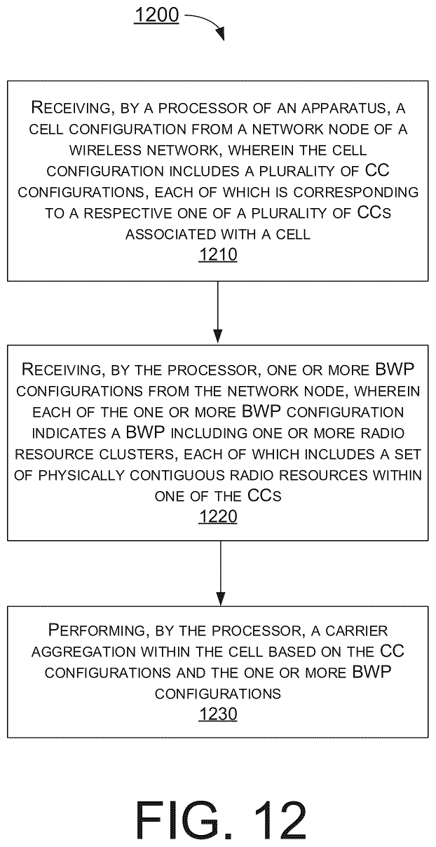

FIG. 12 illustrates an example process 1200 in accordance with an implementation of the present disclosure. Process 1200 may be an example implementation of above scenarios/schemes, whether partially or completely, with respect to efficient spectrum aggregation with a multi-cluster BWP in mobile communications. Process 1200 may represent an aspect of implementation of features of communication apparatus 1010. Process 1200 may include one or more operations, actions, or functions as illustrated by one or more of blocks 1210 to 1230. Although illustrated as discrete blocks, various blocks of process 1200 may be divided into additional blocks, combined into fewer blocks, or eliminated, depending on the desired implementation. Moreover, the blocks of process 1200 may be executed in the order shown in FIG. 12 or, alternatively, in a different order. Process 1200 may be implemented by communication apparatus 1010 or any suitable UE or machine type devices. Solely for illustrative purposes and without limitation, process 1200 is described below in the context of communication apparatus 1010. Process 1200 may begin at block 1210.

At 1210, process 1200 may involve a processor (e.g., processor 1012) of an apparatus (e.g., communication apparatus 1010) receiving, via a transceiver (e.g., transceiver 1016), a cell configuration from a network node (e.g., network apparatus 1020) of a wireless network (e.g., 5G NR network), wherein the cell configuration includes a plurality of CC configurations, each of which is corresponding to a respective one of a plurality of CCs associated with a cell. Process 1200 may proceed from 1210 to 1220.

At 1220, process 1200 may involve the processor receiving, via the transceiver, one or more BWP configurations from the network node, wherein each of the one or more BWP configuration indicates a BWP including one or more radio resource clusters, each of which includes a set of physically contiguous radio resources within one of the CCs. Process 1200 may proceed from 1220 to 1230.

At 1230, process 1200 may involve the processor performing a carrier aggregation within the cell based on the CC configurations and the one or more BWP configurations.

In some implementations, the radio resource clusters of the BWP share an SCS and a cyclic prefix CP.

In some implementations, each of the CC configurations indicates a frequency location and a bandwidth size of a respective one of the CCs.

In some implementations, the BWP is an initial DL BWP provided by a SSB in a case that the BWP includes only one radio resource cluster.

In some implementations, the BWP is an initial DL BWP provided by system information in a case that the BWP includes only one radio resource cluster or multiple radio resource clusters.

In some implementations, the BWP is an initial UL BWP provided by system information in a case that the BWP includes only one radio resource cluster or multiple radio resource clusters.

In some implementations, process 1200 may further involve the processor receiving, via the transceiver, TDD configurations from the network node. Each of the TDD configuration is associated with a respective one of the radio resource clusters and indicates which slot or OFDM symbols of a slot in a radio frame is or are configured for DL or UL.

In some implementations, process 1200 may further involve the processor receiving, via the transceiver, bitmaps from the network node. Each of the bitmaps is associated with a respective one of the radio resource clusters and indicates which slot is applicable for the TDD configuration of the associated radio resource cluster to override a per-carrier TDD configuration.

In some implementations, one of the CCs is configured with a sub-band full duplex mode in a case that more than one of the radio resource clusters is located in the one of the CCs and is associated with multiple TDD configurations.

In some implementations, one of the radio resource clusters overlaps another one of the radio resource clusters.

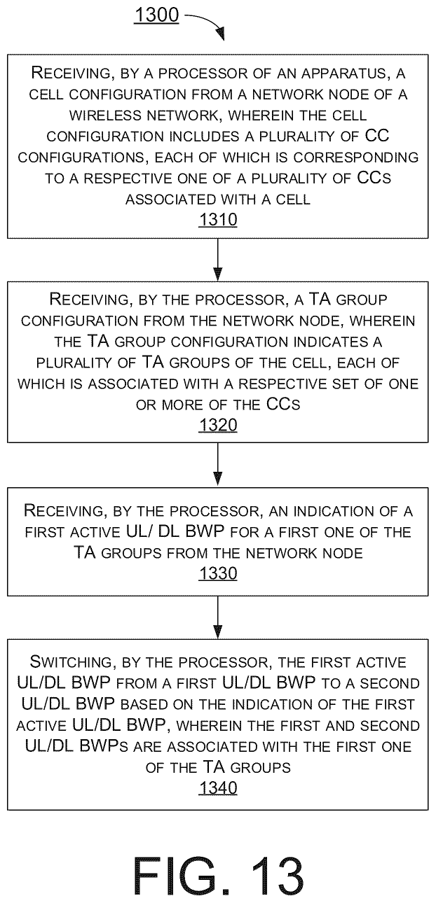

FIG. 13 illustrates an example process 1300 in accordance with an implementation of the present disclosure. Process 1300 may be an example implementation of above scenarios/schemes, whether partially or completely, with respect to efficient spectrum aggregation with multiple TA groups in mobile communications. Process 1300 may represent an aspect of implementation of features of communication apparatus 1010. Process 1300 may include one or more operations, actions, or functions as illustrated by one or more of blocks 1310 to 1340. Although illustrated as discrete blocks, various blocks of process 1300 may be divided into additional blocks, combined into fewer blocks, or eliminated, depending on the desired implementation. Moreover, the blocks of process 1300 may be executed in the order shown in FIG. 13 or, alternatively, in a different order. Process 1300 may be implemented by communication apparatus 1010 or any suitable UE or machine type devices. Solely for illustrative purposes and without limitation, process 1300 is described below in the context of communication apparatus 1010. Process 1300 may begin at block 1310.

At 1310, process 1300 may involve a processor (e.g., processor 1012) of an apparatus (e.g., communication apparatus 1010) receiving, via a transceiver (e.g., transceiver 1016), a cell configuration from a network node (e.g., network apparatus 1020) of a wireless network (e.g., 5G NR network), wherein the cell configuration includes a plurality of CC configurations, each of which is corresponding to a respective one of a plurality of CCs associated with a cell. Process 1300 may proceed from 1310 to 1320.

At 1320, process 1300 may involve the processor receiving, via the transceiver, a TA group configuration from the network node, wherein the TA group configuration indicates a plurality of TA groups of the cell, each of which is associated with a respective set of one or more of the CCs. Process 1300 may proceed from 1320 to 1330.

At 1330, process 1300 may involve the processor receiving, via the transceiver, an indication of a first active UL/DL BWP for a first one of the TA groups from the network node. Process 1300 may proceed from 1330 to 1340.

At 1340, process 1300 may involve the processor switching the first active UL/DL BWP from a first UL/DL BWP to a second UL/DL BWP based on the indication of the first active UL/DL BWP, wherein the first and second UL/DL BWPs are associated with the first one of the TA groups.

In some implementations, the first active UL/DL BWP includes one or more radio resource clusters, each of which includes a set of physically contiguous radio resources within one of the CCs belonging to the first one of the TA groups.

In some implementations, the radio resource clusters of the first active UL/DL BWP share an SCS and a CP.

In some implementations, each of the CC configurations indicates a frequency location and a bandwidth size of a respective one of the CCs.

In some implementations, process 1300 may further involve the processor receiving, via the transceiver, an indication of a second active UL/DL BWP for a second one of the TA groups from the network node, and switching the second active UL/DL BWP from a third UL/DL BWP to a fourth UL/DL BWP based on the indication of the second active UL/DL BWP. The third and fourth UL/DL BWPs are associated with the second one of the TA groups.

In some implementations, transmission (Tx) or reception (Rx) scheduling across the first and second active UL/DL BWPs is not allowed.

In some implementations, the respective sets of one or more of the CCs, that are associated with different TA groups are provided by different network nodes.

In some implementations, multiple PDSCH/PUSCH configurations are configured for the cell in a case that the CCs are located across different frequency bands or provided by different network nodes.

In some implementations, the cell configuration or the TA group configuration is received via a higher-layer signaling including system information broadcast or UE-specific RRC signaling.

In some implementations, the indication of the first active UL/DL BWP is received via a higher-layer signaling carried in a PDSCH or via a physical-layer signaling carried in a physical downlink control channel (PDCCH).

In some implementations, the indication of the second active UL/DL BWP is received via a higher-layer signaling carried in a PDSCH or via a physical-layer signaling carried in a PDCCH.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a cell configuration from a network node of a wireless network, wherein the cell configuration comprises a plurality of component carrier (CC) configurations, each of which is corresponding to a respective one of a plurality of CCs associated with a cell;
receiving, by the processor, one or more bandwidth part (BWP) configurations from the network node, wherein each of the one or more BWP configuration indicates a BWP comprising one or more radio resource clusters, each of which comprises a set of physically contiguous radio resources within one of the CCs; and
performing, by the processor, a carrier aggregation within the cell based on the CC configurations and the one or more BWP configurations.

2. The method of claim 1, wherein the radio resource clusters of the BWP share a subcarrier spacing (SCS) and a cyclic prefix (CP).

3. The method of claim 1, wherein each of the CC configurations indicates a frequency location and a bandwidth size of a respective one of the CCs.

4. The method of claim 1, wherein the BWP is an initial DL BWP provided by a synchronization signal block (SSB) in a case that the BWP comprises only one radio resource cluster.

5. The method of claim 1, wherein the BWP is an initial DL BWP provided by system information in a case that the BWP comprises only one radio resource cluster or multiple radio resource clusters.

6. The method of claim 1, wherein the BWP is an initial UL BWP provided by system information in a case that the BWP comprises only one radio resource cluster or multiple radio resource clusters.

7. The method of claim 1, further comprising:
receiving, by the processor, time-division duplexing (TDD) configurations from the network node, wherein each of the TDD configuration is associated with a respective one of the radio resource clusters and indicates which slot or orthogonal frequency-division multiplexing (OFDM) symbols of a slot in a radio frame is or are configured for downlink (DL) or uplink (UL).

8. The method of claim 7, further comprising:
receiving, by the processor, bitmaps from the network node, wherein each of the bitmaps is associated with a respective one of the radio resource clusters and indicates which slot is applicable for the TDD configuration of the associated radio resource cluster to override a per-carrier TDD configuration.

9. The method of claim 1, wherein one of the CCs is configured with a sub-band full duplex mode in a case that more than one of the radio resource clusters is located in the one of the CCs and is associated with multiple TDD configurations.

10. The method of claim 1, wherein one of the radio resource clusters overlaps another one of the radio resource clusters.

11. An apparatus, comprising:
a transceiver which, during operation, wirelessly communicates with a network node of a wireless network; and
a processor communicatively coupled to the transceiver such that, during operation, the processor performs operations comprising:
receiving, via the transceiver, a cell configuration from the network node of the wireless network, wherein the cell configuration comprises a plurality of component carrier (CC) configurations, each of which is corresponding to a respective one of a plurality of CCs associated with a cell;
receiving, via the transceiver, one or more bandwidth part (BWP) configurations from the network node, wherein each of the one or more BWP configuration indicates a BWP comprising one or more radio resource clusters, each of which comprises a set of physically contiguous radio resources within one of the CCs; and
performing, via the transceiver, a carrier aggregation within the cell based on the CC configurations and the one or more BWP configurations.

12. The apparatus of claim 11, wherein the radio resource clusters of the BWP share a subcarrier spacing (SCS) and a cyclic prefix (CP).

13. The apparatus of claim 11, wherein each of the CC configurations indicates a frequency location and a bandwidth size of a respective one of the CCs.

14. The apparatus of claim 11, wherein the BWP is an initial DL BWP provided by a synchronization signal block (SSB) in a case that the BWP comprises only one radio resource cluster.

15. The apparatus of claim 11, wherein the BWP is an initial DL BWP provided by system information in a case that the BWP comprises only one radio resource cluster or multiple radio resource clusters.

16. The apparatus of claim 11, wherein the BWP is an initial UL BWP provided by system information in a case that the BWP comprises only one radio resource cluster or multiple radio resource clusters.

17. The apparatus of claim 11, wherein, during operation, the processor further performs operations comprising:
receiving, via the transceiver, time-division duplexing (TDD) configurations from the network node, wherein each of the TDD configuration is associated with a respective one of the radio resource clusters and indicates which slot or orthogonal frequency-division multiplexing (OFDM) symbols of a slot in a radio frame is or are configured for downlink (DL) or uplink (UL).

18. The apparatus of claim 17, wherein, during operation, the processor further performs operations comprising:
receiving, via the transceiver, bitmaps from the network node, wherein each of the bitmaps is associated with a respective one of the radio resource clusters and indicates which slot is applicable for the TDD configuration of the associated radio resource cluster to override a per-carrier TDD configuration.

19. The apparatus of claim 11, wherein one of the CCs is configured with a sub-band full duplex mode in a case that more than one of the radio resource clusters is located in the one of the CCs and is associated with multiple TDD configurations.

20. The apparatus of claim 11, wherein one of the radio resource clusters overlaps another one of the radio resource clusters.
